(19) United States
(12) Patent Application Publication
(10) Pub. No.: US 2018/0285470 A1
(43) Pub. Date: Oct. 4, 2018

(54) A Mobile Web Cache Optimization Method Based on HTML5 Application Caching

(71) Applicant: Peking University, Beijing (CN)

(72) Inventors: Xuanzhe Liu, Beijing (CN); Gang Huang, Beijing (CN); Yun Ma, Beijing (CN); Shuailiang Dong, Beijing (CN); Hong Mei, Beijing (CN)

(21) Appl. No.: 15/514,632

(22) PCT Filed: Sep. 7, 2016
(86) PCT No.: PCT/CN2016/098292

§ 371 Date: Mar. 27, 2017

(30) Foreign Application Priority Data
Dec. 23, 2015 (CN) 201510980489.8

(51) Int. Cl. G06F 17/30; H04L 29/08; G06F 9/445

(52) U.S. Cl. CPC G06F 17/30902; G06F 17/30864; H04L 67/02; G06F 9/44568; H04L 67/2842

(57) ABSTRACT

The present invention discloses a mobile web cache optimization method including the steps of: 1) crawling the resource information in the mobile web application by a server; 2) mapping resources having the same content but different URLs to a same resource; 3) selecting a stable set of resources to configure in the cache resource list; 4) setting a JavaScript runtime library, invoking a call to the runtime in each target page; 5) generating a proxy page for each target page, redirecting URL of a target page to the corresponding proxy page, and when a target page is accessed, querying the resource mapping file according to the requested resource, and retrieving the matching cache resource from the cache resource list to load onto the proxy page. The disclosed method saves the access time and reduces data traffic of the mobile web application and improves user experience of the mobile devices.

### TECHNICAL FIELD

The present invention relates to the field of computer technology, and in particular, to a mobile web cache optimization method based on HTML5 application cache.

### BACKGROUND OF THE INVENTION

Web application is a software application that employs HTML, JavaScript, CSS and other web technologies, and accesses through web browsers. Web application is also one of the most important forms of software applications on mobile devices. Compared to traditional personal computers, mobile devices have limited computing capacity, poor network connectivity, slower access speed to mobile web applications, and higher consumption of data traffic, which can seriously affect user experience of mobile web applications. Caching is an important technical tool for improving performance of web application. A web application consists of a number of web resources. Cache stores downloaded web resources in local storage, which allows the resources to be directly loaded from the local resources when these resources are requested again. Caching can reduce the number of network requests, thereby reducing the amount of data traffic consumed by web applications, and thus increasing the loading speed of web applications. Moreover, local resources also save the computing resources of mobile devices, which is consistent with the light computing requirements of mobile devices.

The traditional web caching is based on the cache mechanism provided by the HTTP protocol. This cache mechanism provides two models: the expiration model requires the developer to configure an expiration time for the web resource; the browser can load the resource directly from the cache before expiration. The validation model requires the developer to configure an identity for the web resource, which is used as the unique identifier for modifying time. When the resource expires, the browser sends the configured web resource identifier to the server, and the server determines whether the corresponding web resource has changed based on the identifier. If there is no change, only header information is returned. Otherwise, the server returns updated web resource to the browser. In practice, because web cache is often inappropriately configured by developers and a large number of dynamic resources are present, mobile web caching often suffers performance problems, resulting in a large number of redundant requests, which affects the performance of mobile web applications.

The development and popularization of HTML5 have brought new technical approaches to optimize user experiences with mobile web application. Application Cache is an offline application interface provided by HTML5: A web developer can create a Manifest file, declare a list of resources that can be locally cached, and configure the Manifest file on the main HTML page of the web application. As a result, when the user accesses the web application offline, the resources declared in the Manifest file can be read directly from the local cache. When the user is online, the browser automatically checks the update status of the Manifest file, and can automatically updates all resources declared by Manifest when changes are detected in the Manifest file. The HTML5 application cache actually provides a fine-grained control interface for web application caching. Accordingly, the present invention proposes an automated development technique to help developers optimize caching in mobile web applications.

### SUMMARY OF THE INVENTION

To address the above described problems in web application caching on mobile devices, an object of the present invention is to provide a method for optimizing mobile web caching based on the HTML5 application cache.

The key features of disclosed method are as follows: for a mobile web application, a server automatically acquires the update status of resources involved in the mobile web application, predicts the update time of each resource so as to selects a more stable set of resources to configure in the Manifest file of HTML5 application cache. The server updates the Manifest file when changes occur in the resource content in the Manifest file. On the client side, the browser provides a JavaScript runtime library which can be incorporated into mobile web applications by developers, which enables mobile web applications to take advantage of HTML5 application caching. The present invention method allows developers to quickly and easily improve their applications.

The invention includes three parts:

1. A tool that runs on the server side that automatically generates, maintains, and updates the Manifest file.

2. A JavaScript library that runs in the client browser.

3. A set of deployment plan.

The core of the present invention is a tool that analyzes the resource data of the mobile web application and maintains the Manifest list, thereby providing a valid caching service for the client. The core tool conducts four steps:

1. Automatically crawling. The tool crawls all the resources under a given mobile web application at predetermined intervals to obtain resource information at different time points.

2. Resource mapping. The tool maps the URL of each resource to a regular expression. The resources that are matched to the same regular expression are treated as the same resource. That is, for resources that have the same content but different URLs (such as a.jpg? 123 and a.jpg? 345), the crawling by the server determines that they have the same content (e.g. same picture), and a common expression is generated to replace the two resources. By generating common regular expression for URLs of the same original content, the repeated downloading of these resources can be prevented.

3. Forecasting time. Learning and identifying the pattern of resource changes based on the resource information at each time point, and predicting the time duration in which the resources maintain to be unchanged.

4. Selecting resources. Based on the results of the predicted time, determining the best combination of resources, generating or updating the Manifest configuration file for HTML5 application cache.

The specific technical steps of the above steps are as follows:

1. Automatically crawling. The tool automatically crawls resources of the target mobile web application at predetermined intervals, and accesses resource information at different time points. The tool continuously accesses the page at the specified URL and renders the page at the intervals, parses the resources contained in the web page, acquires resource information such as the size of the resource, MD5 value of the resource content, and the cache time configuration of the resource. The access interval can be given by the developer based on the actual situation of the site, or can be automatically selected by the tool.

2. Resource mapping. The tool supports identifying resources having dynamically changing URLs. In the resources acquired in the first step, many are dynamically generated. These resources have different URLs even if they have identical content. The tool maps them to the same resource. For example, AJAX dynamically requested resources often have identical AJAX timestamps and host name, path name, port number. In the mapping step, these time-stamped resources are mapped to the same resource. It is worth noting that the correspondence between the URL and the regular expression is relatively fuzzy. If the regular expression corresponding to a group of URL is too broad, there may be a conflict between regular expressions. The tool defaults to a more rigorous method of regular expression generation, that is, generating a mapping target by identifying the longest common substring in a set of different URLs that have the same content. The pseudocode used in the resource mapping algorithm is as follows:

| | Input: last set of normalized resources Hₜ₋₁, current |
|---|---|
| | set of concrete resources Rₜ |
| | Output: updated set of normalized resources Hₜ |
| 1 | INITIAL Hₜ ← Hₜ₋₁; |
| 2 | foreach h ∈ Hₜ do |
| 3 | \| INITIAL h.statusₜ ← “inexistent”; |
| 4 | end |
| 5 | foreach r ∈ Rₜ do |
| 6 | \| P ← FindSameURL(Hₜ, r); |
| 7 | \| q ← FindSameMD5(Hₜ, r); |
| 8 | \| if q ≠ null then |
| 9 | \| \| q.expression ← |
| | \| \| CalRegExpr(q.expression, r.url); |
| 10 | \| \| q.statusₜ ← “unchanged”; |
| 11 | \| end |
| 12 | \| else if P.size = 1 then |
| 13 | \| \| P.statusₜ ← “changed”; |
| 14 | \| \| UpdateResource(P); |
| 15 | \| end |
| 16 | \| else |
| 17 | \| \| RemoveResource(P); |
| 18 | \| \| AddResource(r); |
| 19 | \| end |
| 20 | end |
| 21 | CheckMapping(Rₜ, Hₜ); |
| 22 | return Hₜ; |

The algorithm receives a regular resource list Ht−1 at time t−1 and a detailed resource list Rt at time t as input, and generates a regularized resource list Ht at time t. Regularization means that the resources in H that can be uniquely identified by regular expressions. The algorithm first conducts initialization (L1-L4), initializes the regularized resource list Ht at time t to the regularized resource list Ht−1 at time t−1, and sets the state of each resource to “nonexistent”. The main part (L5-L20) of the algorithm is to obtain a mapping relation between the URL and the regular expression in the Ht for each resource r in R. If there is no resource in Ht corresponds to r, a record for r is added in Ht (L12-L15). If Ht includes a unique resource corresponding to r, r is mapped to Ht and the regular expression of the resource r is recalculated (L8-L11). If Ht includes multiple resources corresponding to r, then the original mapping fails, the original mapping is deleted, and a new record for r is added to Ht (L16-L19).

3. Forecast time. By crawling historical information. The time duration that each resource remains unchanged is predicted. Only resources that remain unchanged for a long period of time can produce meaningful benefits when they are allocated to application cache. Conversely, if resources placed in the application cache change too frequently, the entire application cache has to be constantly refreshed, which offsets the benefit of optimization, and is thus not worthwhile. In the implementation, the tool extracts MD5 value for each resource at each time from the historical information, obtains a time series of the changes to the MD5 values, and finally completes the prediction with the linear regression based on the time series. The pseudo-code of the algorithm for predicting time is as follows:

| | Input: historic status status₀,...,statusₜ of a |
|---|---|
| | normalized resource h ∈ Hₜ, visiting interval vi |
| | Output: predicted update time of h |
| 1 | if h.statusₜ = “inexistent” then |
| 2 | \| h.predictedtime ← 0; |
| 3 | end |
| 4 | else |
| 5 | \| h.predictedtime ← GDM(status₀,...,statusₜ); |
| 6 | \| if h.predictedtime = inf then |
| 7 | \| \| h.predictedtime ← \|status.unchanged\| * vi; |
| 8 | \| end |
| 9 | end |
| 10 | if h.predictedtime = 0 then |
| 11 | \| RemoveResource(h); |
| 12 | end |

The input of the algorithm is the historical state information of a resource. Historical states can include three types: no change, change, and nonexistent. According to the characteristics of the network resource, if a resource disappears at a time, the probability for that resource to appear at the next moment is relatively small. Therefore, the algorithm predicts the time to be 0 for the resource with the current state as “nonexistent” (L1-L3). For other resources, the algorithm can use linear regression to predict the time of change. One suitable method is the gradient descent method (GDM), which is a commonly used efficient linear regression algorithm, also available online (L4-L9). Finally, the algorithm is also responsible for deleting those resources with short forecast times, reducing the number of resources that need to be processed, and improving computation efficiency (L10-L12)

4. Selecting resources. In this step, the tool takes into account many aspects of a resource, weighing the pros and cons of putting the resources in the application cache. Factors that can affect whether a resource is cached are: the size of the resource, the predicted time duration that the resource stays the same, the configuration of the cache, and user access distribution of the mobile web application. In general, large resources and longer stable resources would result in better benefits by caching. Caching configuration can also have a great impact on the resource cache: resources having longer stable times can work very well using the HTTP cache protocol; correspondingly, the shorter the resource cache configuration time, the greater the additional benefits. Finally, the user access distribution of accessing the application can also affect the selection of resources. The tool weighs the various factors, calculates the best combination of resources, and configures the combination of resources into the Manifest file for the HTML5 application caching. The pseudo-code of the algorithm for selecting resources is as follows:

| | Input: current set of normalized resources Hₜ, user |
|---|---|
| | distribution σ |
| | Output: resource package M |
| 1 | sort Hₜ based on its predicted time in ascending order; |
| 2 | for i ← 0 to \|Hₜ\| do |
| 3 | \| benefit(i) ← 0; |
| 4 | \| T ← Hᵢ.predictedtime; |
| 5 | \| for j ← i to \|Hₜ\| do |
| 6 | \| \| if Hⱼ.cacheduration < T then |
| 7 | \| \| \| benefit(i) += |
| | \| \| \| σ(Hⱼ.cacheduration, T) * Hⱼ.size; |
| 8 | \| \| end |
| 9 | \| end |
| 10 | end |
| 11 | select i where benefit(i) is the largest; |
| 12 | M ← Hₜ(i, i + 1, ..., \|Hₜ\|); |
| 13 | return Mₜ; |

Since the overall update time for a list of resources depends on the most frequently updated resource in the list, the algorithm sequences a list of resources by their update times from short to long update times. Given an update time, the transmission traffic that can be by putting a resource into the application cache can be expressed as L7. L7 is expressed by: traffic that can be saved by putting a resource into the application cache is resulted from the difference between the expected cache time after the resource is cached and the previous default cache time, namely:

Traffic that can be saved by caching a resource=(expected cache time−the cache time of the resource)*the size of the resource (1)

The above formula multiplying user access distribution gives the overall savings in network traffic. Thus, for a given update time Ti,

benefit(i)=Σjσ(caching time Ti configured for Hj)*the size of resource Hj (2)

wherein σ is the user access distribution. Thus the application caching benefit(i) can be calculated by enumerating all possible combinations for the set of resources (L2-L10). The final algorithm selects the combination that gives the largest benefit, that is, the maximum of all benefit (i), and sets the corresponding collection of resources to the Manifest file in HTML5 application caching.

Running the JavaScript library in the client browser, including:

1. The interface for intercepting page request and obtaining the request URL. Calling the interface in the page, automatically intercepting all the URLs requested in the process of page resolution, and comparing with the list of resources in the application cache. If the list includes mapping of regular expressions of the resources, URLs can be automatically replaced, thus avoiding redundant transmissions of resources.

2. Interaction with HTML5 application cache. This includes query, detection, regular expression, and comparison, etc. of the cached resources.

Implementations:

This tool provides developers with a complete deployment plan. The deployment can include three steps: the first step, a JavaScript library is added in the target page. The second step, a blank page is generated as a proxy page, and the URL of original home page is redirected to the proxy page. The original home page becomes a resource that can be requested by the proxy page. The blank page is called proxy page because it can be used to load the resources of the original page. The tool is run in the third step. The JavaScript library is called in the first step to enable the original page have the ability of intercepting URL requests and caching information. Due to limitations in the HTML5 application cache, after the deployment, application page needs to be changed to an automatically generated proxy page, which can also be requested as a resource by the proxy page (generated in step 2). Here the first and the second steps are programmed and can be automatically accomplished by the tool.

It should be noted that the URL of the original web page needs to be redirected to a newly generated proxy page. The reason for such redirection is to solve a drawback in the application caching of HTML pages. The disclosed deployment is more general. For a website with a fixed home page, the second step of the deployment can also be omitted. The above two methods are programmed and can be automatically accomplished by the tool, or can also be manually invoked by the developer.

Compared with the conventional technologies, the disclosed invention method can include the following benefits: the disclosed method conveniently and effectively obtains network resource information using the disclosed tool, effectively increasing caching hit rate for the resources by advance forecasting time, reducing access times, and improving user experiences of the mobile devices.

### BRIEF DESCRIPTION OF THE DRAWINGS

FIG. 1 is a flow diagram in the disclosed invention.

### DETAILED DESCRIPTION OF IMPLEMENTATIONS

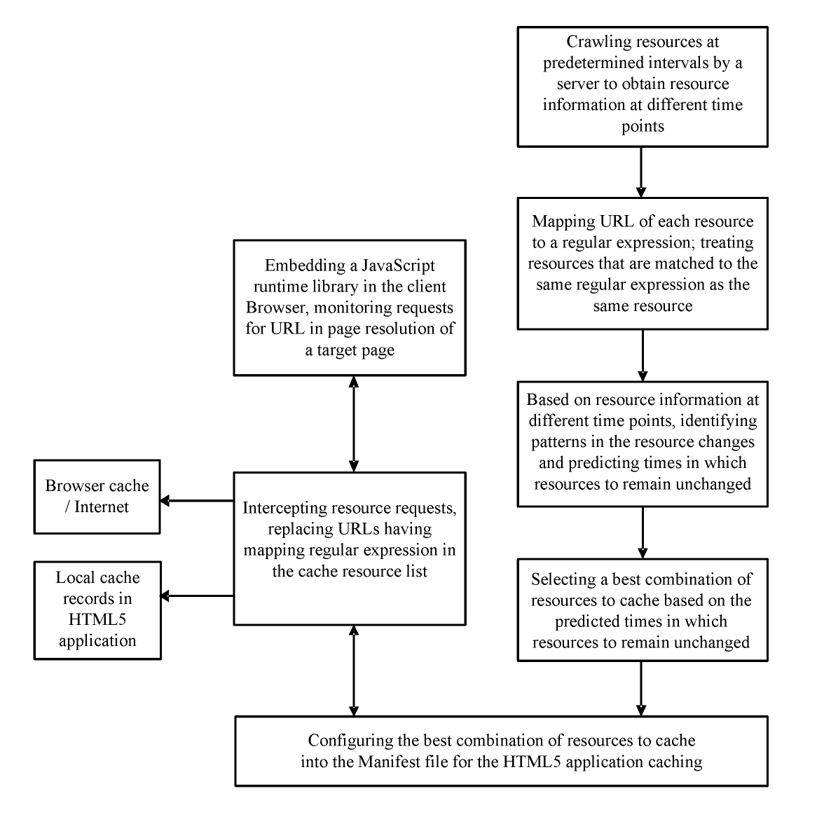

This section describes an example of applying the disclosed caching method at the website of the School of Information Science and Technology at Peking University (http: followed by //eecs.pku.edu.cn). The processing flow is shown in the FIG. 1. The website is the portal for the School of Information Science and Technology at Peking University, which contains the news about the college, announcements, curricular information, lecture information, and other information.

First, a command is invoked to embed a JavaScript library in the HTML file of the original home page, which is provided with the task of automatically intercepting and resolving URL requests, and interacting with the cache list.

Next, a proxy page is generated, and the URL of the original home page is redirected to the proxy page. The original home page becomes a resource that can be requested by the proxy page. Afterwards, when the original URL is visited, such as http: followed by //eecs.pku.edu.cn, the client first requests the proxy page, and then in the proxy page requests for all the original resources. If some of these resources have URLs that can be effectively mapped to regular expressions recorded in the resource list, the previously added JavaScript function automatically replaces these URL and instead requests them from the cache resource.

Finally, the server side automatically runs the tool. The tool automatically crawls and parses the page, provides and maintains the cache resource list Manifest on the server side, the cache resource list Manifest containing information about the resources, and connects the application cache interface to the proxy page.

Users still access the web application through the original URL, but enjoying much better experiences.

What is claimed is:

1. A method for optimizing mobile web cache based on HTML5 application cache, comprising the steps of:
1) crawling resources of a mobile web application by a server at predetermined interval to obtain the resource information;
2) mapping the resources having same content but different URLs to a same resource by the server;
3) predicting a time duration in which each of the resources is to be unchanged based on the resource information; selecting a stable set of resources to configure in a cache resource list in Manifest file associated with the HTML5 application cache; and generate a resource mapping file to preserve mapping relationship between the resources and corresponding URLs;
4) setting a JavaScript runtime library; invoking a call command for the JavaScript runtime library in each target page; automatically blocking a URL resolution request of a target page when the target page is assessed by a client browser, wherein the target page is a page of a mobile web application, each target page associated with a number of resources; and
5) generating a proxy page for a target page; redirecting URL of the target page to the corresponding proxy page; accessing a target page through the client browser including a requested resource; querying the resource mapping file according to the requested resource to find a mapped resource; and retrieving a mapped resource from the cache resource list in the Manifest file and loading the mapped resource to the proxy page.

2. The method of claim 1, wherein the resource information includes a size of the resource, MD5 value of the resource, and a buffer time allocation of the resource.

3. The method of claim 2, further comprising:
extracting MD5 values of each of the resources at different times from the resource information; and
acquiring a time series of changes to the MD5 values in each of the resources,
wherein the time duration in which each of the resources is to be unchanged is predicted based on the time series of changes to the MD5 values in each of the resources.

4. The method of 1, wherein the step of mapping the resources having same content but different URLs to a same resource includes:
receiving a regular resource list Ht−1 at time t−1 and a detailed resource list Rt at time t;
generating a regularized resource list Ht at time t;
initializing the regularized resource list Ht at time t to the regularized resource list Ht−1 at time t−1;
setting state of each resource to “nonexistent”;
for each resource r in R, adding a record for r is added in Ht if there is no resource in Ht corresponds to r;
if Ht includes a unique resource corresponding to r, mapping r to Ht and recalculating the regular expression of the resource r; and
if Ht includes multiple resources corresponding to r, deleting the original mapping and adding a new record to Ht for r.

5. The method of claim 1, further comprising:
selecting a set of resources to configure into the cache resource list in the Manifest file based on the size of the resource, the predicted time that the resource is to remain unchanged, a cache configuration, or a user access distribution of the mobile web application.

6. The method of claim 5, wherein the method of selecting a set of resources comprises:
calculating a total benefit in traffic saved by caching a set of resources in the cache resource list of the Manifest file at a given time Ti; and
selecting a combination of resources that gives the largest benefit configure into the Manifest file in HTML5 application caching.

7. The method of claim 6, wherein the traffic saved by configuring the set of resources into the application cache is the difference between an expected cache time after the resource is cached and a previous default cache time.

8. The method of claim 1, further comprising:
updating the Manifest file by the server when content of one of the resources cached in the Manifest file changes.
